(19) United States
(12) Patent Application Publication
(10) Pub. No.: US 2014/0129270 A1
(43) Pub. Date: May 8, 2014

(54) APPARATUS AND METHOD FOR MANAGING LOCATIONS OF SERVICE EQUIPMENT FOR PLANT FACTORY

(71) Applicant: Electronics and Telecommunications Research Institute, Daejeon (KR)

(72) Inventors: Daeheon PARK, Suncheon-si Jeollanam-do (KR); Sehan KIM, Daejeon (KR); Hoon JEONG, Daejeon (KR); Hyeon PARK, Daejeon (KR); Cheolsig PYO, Daejeon (KR); Byungbog LEE, Daejeon (KR); Hyochan BANG, Daejeon (KR)

(73) Assignee: Electronics and Telecommunications Research Institute, Daejeon (KR)

(21) Appl. No.: 14/068,390

(22) Filed: Oct. 31, 2013

(30) Foreign Application Priority Data
Nov. 6, 2012 (KR) 10-2012-0125049
Jun. 26, 2013 (KR) 10-2013-0073803

(51) Int. Cl. G06Q 10/06

(52) U.S. Cl. CPC G06Q 10/0631
USPC 705/7.12

(57) ABSTRACT

Disclosed herein are an apparatus and method for managing the locations of service equipment for a plant factory. The apparatus includes a sensor registration management unit, a sensor ID issuance unit, and a location registration management unit. The sensor registration management unit performs a registration procedure that registers with a sensor network a plurality of service devices and sensors that are installed in the plant factory. The sensor ID issuance unit issues sensor IDs to the plurality of service devices and sensors registered with the sensor network, respectively. The location registration management unit performs a location registration procedure that registers information about the locations of the plurality of service devices and sensors based on the issued sensor IDs.

### CROSS REFERENCE TO RELATED APPLICATIONS

This application claims the benefit of Korean Patent Application Nos. 10-2012-0125049 and 10-2013-0073803, filed on Nov. 6, 2012 and Jun. 26, 2013, respectively, which are hereby incorporated by reference in their entirety into this application.

### BACKGROUND OF THE INVENTION

1. Technical Field

The present invention relates generally to an apparatus and method for managing the locations of service equipment for a plant factory and, more particularly, to an apparatus and method for managing the locations of service equipment for a plant factory, which can register, delete and change the locations of a plurality of service devices and sensors when the service devices and the sensors are installed or moved in a plant factory.

2. Description of the Related Art

Plant factories are systems that are capable of cultivating plants, such as vegetables or seedlings, in facilities regardless of the season in a planned production manner while artificially controlling a cultivation environment including light, temperature, humidity, carbon dioxide concentration and nutrient solutions.

As described above, in plant factories, environmental control factors, such as light, temperature, and humidity, are very important in the cultivation of plants. Since the control of the environment of a plant factory is performed in order to control the plant growth environment which is closely related to the growth of plants, the administrator of the plant factory should know the accurate locations of a plurality of service devices and sensors that monitor the plant growth environment.

In general, in plant factories, three or higher-shelf vertical beds are used as beds for cultivating plants. In each shelf of the cultivation beds, light source devices, such as fluorescent lamps and light emitting-diodes (LEDs), and nutrient supply devices are provided. As the size of a plant factory increases, the number of shelves of each bed and the number of beds increase, and accordingly the number of sensors that monitor the beds increases and also the types of sensors increase, thereby resulting in difficulty determining the accurate locations of the sensors.

Accordingly, recently, indoor location determination technologies, such as RSSI, ToA, TDoA, and AoA, have been researched in pursuit of technologies for determining the indoor locations of service equipment, such as sensors. However, since plant factories are sealed spaces and the sealed spaces are filled with beds composed of steel structures, it is difficult to carry out accurate wireless location determination in plant factories because of diffraction, interference, reflection and cancellation characteristics that are the characteristics of radio waves.

In connection with this, Korean Patent Application Publication No. 10-2011-0079483 discloses technology regarding “Ubiquitous Plant Factory Environment Control System.”

### SUMMARY OF THE INVENTION

Accordingly, the present invention has been made keeping in mind the above problems occurring in the conventional art, and an object of the present invention is to provide an apparatus and method for managing the locations of service equipment for a plant factory, which can register, delete and change the locations of a plurality of service devices and sensors when the service devices and the sensors are installed or moved in a plant factory, thereby being able to collect information about the accurate locations of the service devices and the sensors.

Another object of the present invention is to provide an apparatus and method for managing the locations of service equipment for a plant factory, which can collect information about the locations of a plurality of service devices and sensors via a sensor network and can rapidly control an environment inside the plant factory based on the information about the service devices and the sensors.

In accordance with an aspect of the present invention, there is provided a method of managing the locations of service equipment for a plant factory, including performing a registration procedure that registers with a sensor network a plurality of service devices and sensors that are installed in the plant factory; issuing sensor identifications (IDs) to the plurality of service devices and sensors registered with the sensor network, respectively; and performing a location registration procedure that registers information about the locations of the plurality of service devices and sensors based on the issued sensor IDs.

Performing the registration procedure may include transferring a sensor registration command message to the at least one of the plurality of service devices and sensors through a gateway and an interface; receiving a registration request message for the sensor registration command message from the at least one of the plurality of service devices and sensors through the gateway and the interface; and registering the at least one of the plurality of service devices and sensors with the sensor network.

Performing the location registration procedure may include transferring a location registration command message to at least one of the plurality of service devices and sensors through a gateway and an interface based on the sensor IDs; receiving a location registration completion message for the location registration command message from the at least one of the plurality of service devices and sensors through the gateway and the interface; and storing the information about the final location of the at least one of the plurality of service devices and sensors in a location information database (DB).

The location registration command message may include at least one of a plant factory identification (ID), a plant factory floor ID, a cultivation bed ID, a cultivation bed shelf ID, and spatial information in which the location of the sensor in a shelf of a corresponding cultivation bed has been represented by means of 3D spatial coordinates.

The 3D spatial coordinates may be set in such a way that X, Y, and Z axes are set across a 3D space of the shelf of the cultivation bed so that they are orthogonal to each other, the X axis is uniformly divided into X_left, X_center and X_right along an outward direction from an origin, the Y axis is uniformly divided into Y_right, Y_center and Y_left along the outward direction from the origin, and the Z axis is uniformly divided into Z_low, Z_medium and Z_high along the outward direction from the origin.

The method may further include, after performing the location registration procedure, performing a location change procedure that changes the information about the location of at least one of the plurality of service devices and sensors based on the sensor IDs.

Performing the location change procedure may include transferring a location change command message to the at least one of the plurality of service devices and sensors through a gateway and an interface based on the sensor IDs; and receiving a location change completion message for the location change command message from the at least one of the plurality of service devices and sensors through the gateway and the interface.

The method may further include, after performing the location registration procedure, performing a location deletion procedure that deletes the information about the location of at least one of the plurality of service devices and sensors based on the sensor IDs.

Performing the location deletion procedure may include transferring a location deletion command message to the at least one of the plurality of service devices and sensors through a gateway and an interface based on the sensor IDs; and receiving a location deletion completion message for the location deletion command message from the at least one of the plurality of service devices and sensors through the gateway and the interface.

In accordance with another aspect of the present invention, there is provided an apparatus for managing the locations of service equipment for a plant factory, including a sensor registration management unit configured to perform a registration procedure that registers with a sensor network a plurality of service devices and sensors that are installed in the plant factory; a sensor ID issuance unit configured to issue sensor IDs to the plurality of service devices and sensors registered with the sensor network, respectively; and a location registration management unit configured to perform a location registration procedure that registers information about the locations of the plurality of service devices and sensors based on the issued sensor IDs.

The sensor registration management unit may include a registration command message transmission unit configured to transfer a sensor registration command message transferred by an administrator to at least one of the plurality of service devices and sensors through a gateway and an interface; a registration request message reception unit configured to receive a registration request message for the sensor registration command message from for the location change command message through the gateway and the interface; and a sensor registration unit configured to register the for the location change command message with the sensor network.

The location registration management unit may include a location registration message transmission unit configured to transfer a location registration command message to at least one of the plurality of service devices and sensors through a gateway and an interface based on the sensor IDs; a location registration message reception unit configured to receive a location registration completion message for the location registration command message from the at least one service device or sensor through the gateway and the interface; and a location storage unit configured to store the information about the final location of the at least one service device or sensor in a DB.

The location registration command message may include at least one of a plant factory ID, a plant factory floor ID, a cultivation bed ID, a cultivation bed shelf ID, and spatial information in which the location of the sensor in a shelf of a corresponding cultivation bed has been represented by means of 3D spatial coordinates.

The 3D spatial coordinates may be set in such a way that X, Y, and Z axes are set across a 3D space of the shelf of the cultivation bed so that they are orthogonal to each other, the X axis is uniformly divided into X_left, X_center and X_right along an outward direction from an origin, the Y axis is uniformly divided into Y_right, Y_center and Y_left along the outward direction from the origin, and the Z axis is uniformly divided into Z_low, Z_medium and Z_high along the outward direction from the origin.

The apparatus may further include a location change management unit configured to perform a location change procedure that changes the information about the location of at least one of the plurality of service devices and sensors based on the sensor IDs.

The location change management unit may include a location change message transmission unit configured to transfer a location change command message to the at least one service device or sensor through a gateway and an interface based on the sensor IDs; and a location change message reception unit configured to receive a location change completion message for the location change command message from the at least one service device or sensor through the gateway and the interface.

The apparatus may further include a location deletion management unit configured to perform a location deletion procedure that deletes the information about the location of at least one of the plurality of service devices and sensors based on the sensor IDs.

The location deletion management unit may include a location deletion message transmission unit configured to transfer a location deletion command message to the at least one service device or sensor through a gateway and an interface based on the sensor IDs; and a location deletion message reception unit configured to receive a location deletion completion message for the location deletion command message from the at least one service device or sensor through the gateway and the interface.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of a sensor network environment according to an embodiment of the present invention;

FIG. 2 is a plan view illustrating a floor of a plant factory according to an embodiment of the present invention;

FIG. 3 is a side view illustrating a bed of a plant factory according to an embodiment of the present invention;

FIG. 4 is a diagram illustrating the configuration of an apparatus for managing the locations of service equipment for a plant factory according to an embodiment of the present invention;

FIG. 5 is a diagram illustrating the first shelf of a cultivation bed according to an embodiment of the present invention using 3D spatial coordinates;

FIG. 6 is a side view of the first shelf of the cultivation bed illustrated in FIG. 5;

FIG. 7 is a plan view of the first shelf of the cultivation bed illustrated in FIG. 5;

FIG. 8 is a diagram illustrating the detailed configuration of a sensor registration management unit according to an embodiment of the present invention;

FIG. 9 is a diagram illustrating the detailed configuration of a location registration management unit according to an embodiment of the present invention;

FIG. 10 is a diagram illustrating the detailed configuration of a location change management unit according to an embodiment of the present invention;

FIG. 11 is a diagram illustrating the detailed configuration of a location deletion management unit according to an embodiment of the present invention;

FIG. 12 is a flowchart illustrating a method of managing the locations of service equipment for a plant factory according to an embodiment of the present invention;

FIG. 13 is a diagram illustrating the sequence of a sensor registration procedure according to an embodiment of the present invention;

FIG. 14 is a diagram illustrating a location registration procedure according to an embodiment of the present invention;

FIG. 15 is a diagram illustrating the structure of a location registration completion message according to an embodiment of the present invention;

FIG. 16 is a diagram illustrating a location change procedure according to an embodiment of the present invention; and

FIG. 17 is a diagram illustrating a location deletion procedure according to an embodiment of the present invention.

### DESCRIPTION OF THE PREFERRED EMBODIMENTS

Embodiments of the present invention will be described with reference to the accompanying drawings in order to describe the present invention in detail so that those having ordinary knowledge in the technical field to which the present pertains can easily practice the present invention. It should be noted that like reference numerals are used to designate like elements throughout the drawings as far as possible. In the following description of the present invention, detailed descriptions of known functions and constructions which are deemed to make the gist of the present invention obscure will be omitted.

An apparatus and method for managing the locations of service equipment for a plant factory according to an embodiment of the present invention will be described in detail with reference to the accompanying drawings.

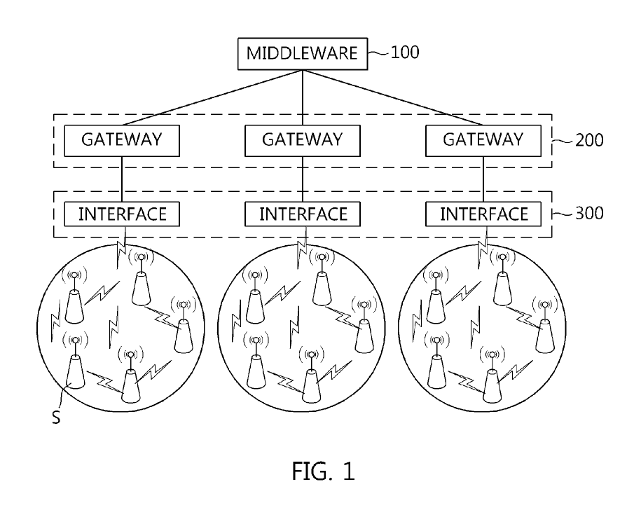

FIG. 1 is a diagram illustrating the configuration of a sensor network environment according to an embodiment of the present invention.

Referring to FIG. 1, the sensor network environment according to this embodiment of the present invention may include a plurality of interfaces 300 configured to collect information about sensor nodes installed in a plant factory; a plurality of gateways 200 configured to finally collect the information collected by the plurality of interfaces 300 and to process the information; and middleware 100 configured to provide the information collected by the gateways 200 to a user. In this case, each of the sensor nodes includes a plurality of sensors S, collects data by sensing data about a surrounding environment, and then transfers the data. The sensor node may be fabricated using various sensors actually applicable to various environments. The sensor node may include a plurality of sensors S, collect information from the sensors, process the information, communicate with the corresponding gateway 200 and the middleware 100 connected over a network, and finally provide real-time information to a user.

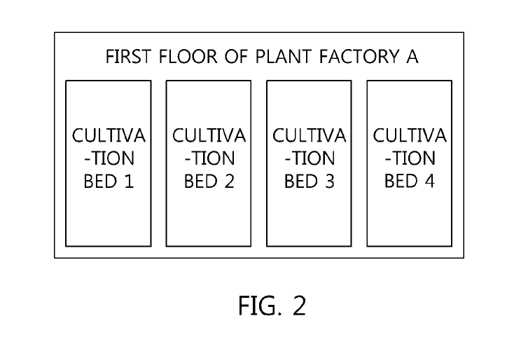

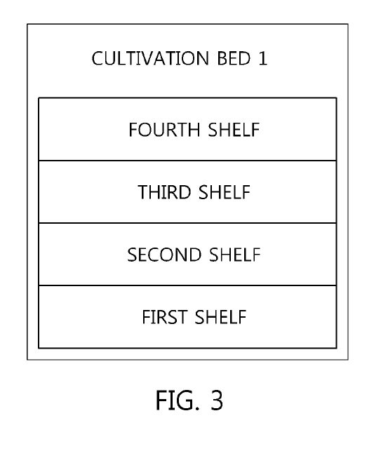

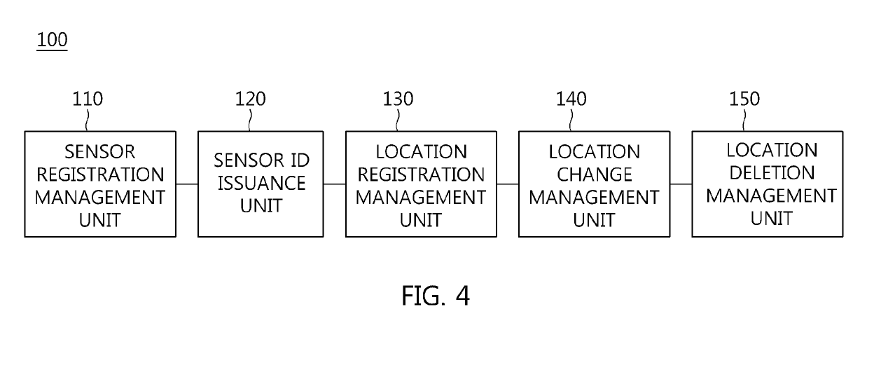

The present invention is directed to an apparatus and method for managing the locations of service equipment for a plant factory, which can register, delete and change the locations of a plurality of service devices and sensors via the middleware 100 when the service devices and the sensors are installed or moved in a plant factory. The configuration of the plant factory that is applied to the present invention will be described in detail below with reference to FIGS. 2 and 3. Embodiments of the apparatus and method for managing the locations of service equipment for a plant factory will be described in detail below with reference to FIGS. 4 to 17.

FIG. 2 is a plan view illustrating a floor of a plant factory according to an embodiment of the present invention, and FIG. 3 is a side view illustrating a bed of a plant factory according to an embodiment of the present invention.

Referring to FIG. 2, a vertical plant factory to which the present invention is applied is fabricated in a form in which multiple horizontal plant factories are stacked on top of another. Plant factories may be divided into plant factory A, and plant factory B, or may be divided into Changwon Plant Factory, Suncheon Plant Factory, Suwon Plant Factory, and Seoul Plant Factory that are built by local organizations and are separated by region.

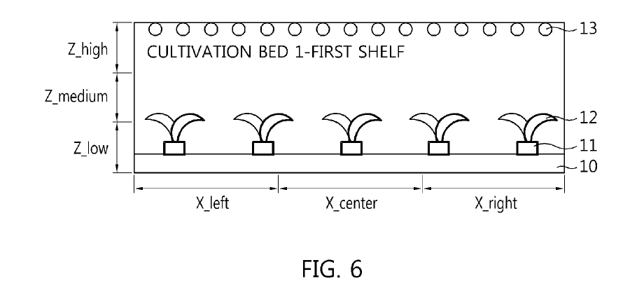

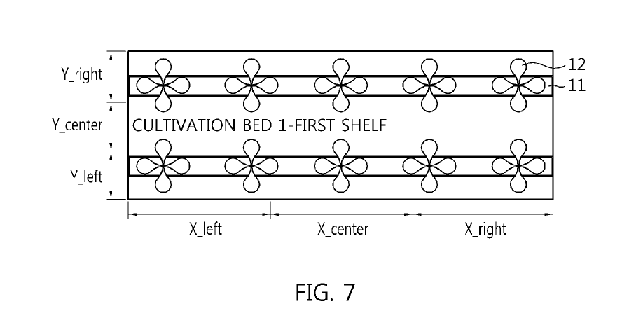

Furthermore, as illustrated in FIG. 3, a plurality of cultivation beds, for example, cultivation bed 1, cultivation bed 2, cultivation bed 3 and cultivation bed 4, are provided in the plant factory. Each of the cultivation beds may be configured in a multi-shelf form. The detailed configuration of the cultivation bed will be described in detail below with reference to FIGS. 6 and 7.

Meanwhile, cultivation beds configured to cultivate plants, a heater configured to supply warm air, a cooler (not illustrated) configured to lower inside temperature, a nutrient solution supply device configured to supply water or nutrients, and a carbon dioxide supply device configured to supply carbon dioxide may be provided on each floor of the plant factory. Furthermore, windows configured to let fresh air in, a ventilator configured to draw inside air out, and a circulation fan configured to mix air well may be further provided.

FIG. 4 is a diagram illustrating the configuration of an apparatus for managing the locations of service equipment for a plant factory according to an embodiment of the present invention.

Referring to FIG. 4, the apparatus for managing the locations of service equipment for a plant factory according to an embodiment of the present invention includes a sensor registration management unit 110, a sensor ID issuance unit 120, a location registration management unit 130, a location change management unit 140, and a location deletion management unit 150. The apparatus for managing the locations of service equipment for a plant factory is operated by the above-described middleware 100.

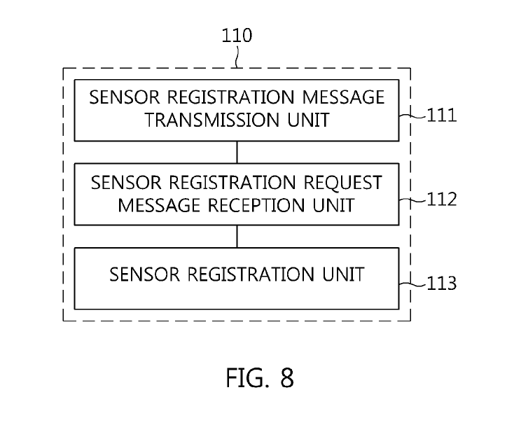

The sensor registration management unit 110 performs a registration procedure that registers with a sensor network a plurality of service devices and sensors S that are installed in the plant factory. In this case, the plurality of service devices and sensors S may be environmental sensors, such as temperature, humidity and illuminance sensors, as well as devices, such light emitting diode lights and actuators, which are used in the plant factory. The configuration of the sensor registration management unit 110 will be described in detail below with reference to FIG. 8. In the following description, for ease of description, the terms “service devices and sensors,” and “service device or sensor” are simply referred to as “sensors” and “sensor,” respectively.

The sensor ID issuance unit 120 issues respective sensor IDs to a plurality of sensors registered with the sensor network. That is, the plurality of sensors registered with the sensor network may be assigned respective unique sensor IDs.

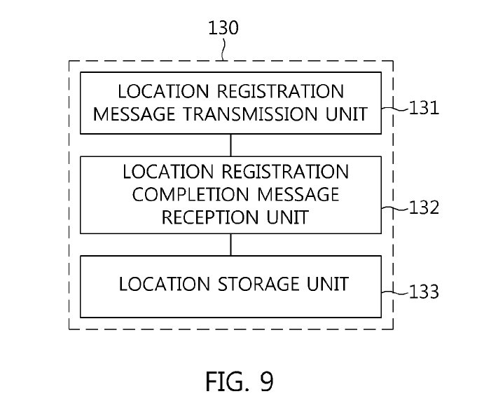

The location registration management unit 130 performs a location registration procedure that registers information about the locations of the plurality of sensors S based on the sensor IDs that are issued to the plurality of sensors S by the sensor ID issuance unit 120. The configuration of the location registration management unit 130 will be described in detail below with reference to FIG. 9.

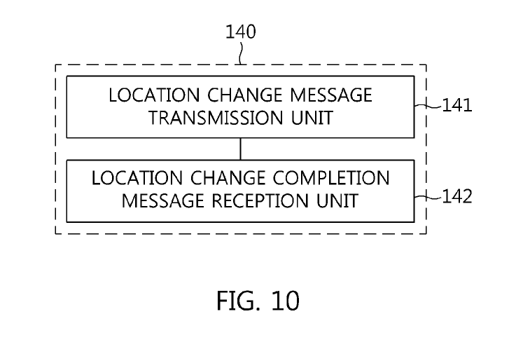

The location change management unit 140 performs a location change procedure that changes information about the locations of the plurality of sensors S. The configuration of the location registration management unit 130 will be described in detail below with reference to FIG. 10.

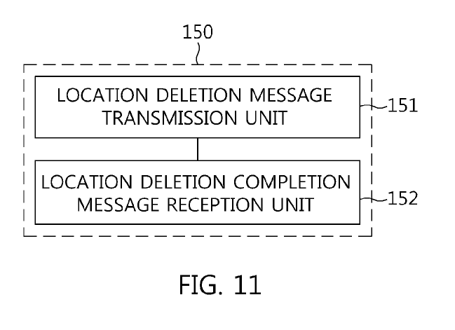

The location deletion management unit 150 performs a location deletion procedure that deletes information about the locations of the plurality of sensors S. The configuration of the location registration management unit 130 will be described in detail below with reference to FIG. 11.

The monitoring unit 160 monitors the plant factory based on the information about the locations of the plurality of sensors S that is managed via the sensor registration management unit 110, the location registration management unit 130, the location change management unit 140, and the location deletion management unit 150.

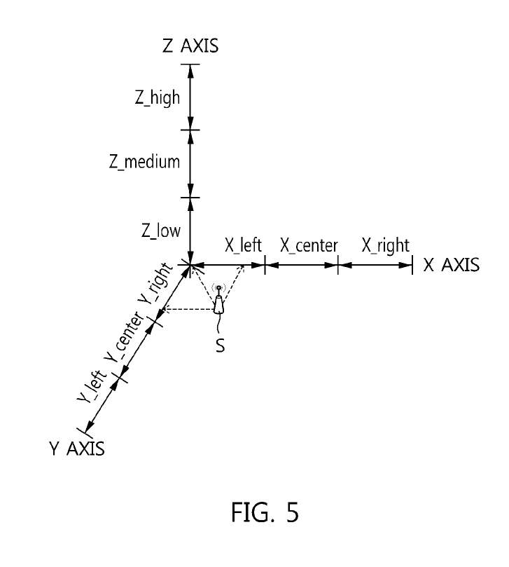

FIG. 5 is a diagram illustrating the first shelf of a cultivation bed according to an embodiment of the present invention using 3D spatial coordinates, FIG. 6 is a side view of the first shelf of the cultivation bed illustrated in FIG. 5, and FIG. 7 is a plan view of the first shelf of the cultivation bed illustrated in FIG. 5.

Referring to FIG. 5, information about the location of at least one sensor S provided in the first shelf of cultivation bed 1 according to this embodiment of the present invention is represented by means of spatial information that is represented by an administrator by means of 3D spatial coordinates. That is, the 3D spatial coordinates may be set in such a way that X, Y, and Z axes are set across the 3D space of the first shelf of cultivation bed 1 so that they are orthogonal to each other, and the X axis is uniformly divided into X_left, X_center and X_right along an outward direction from an origin, the Y axis is uniformly divided into Y_right, Y_center and Y_left along the outward direction from the origin, and the Z axis is uniformly divided into Z_low, Z_medium and Z_high along the outward direction from the origin, as illustrated in FIGS. 5, 6 and 7. For example, as illustrated in FIG. 5, the location of the sensor S installed in the first shelf of cultivation bed 1 disposed on the first floor of the plant factory A is represented as (X_left, Y_right, Z_low) using 3D spatial coordinates. Information about the location of the sensor S is represented as the plant factory A-first floor-cultivation bed 1-first shelf-(X_left, Y_right, Z_low) and input to the middleware 100 by the administrator of the plant factory. That is, the information about the location of the sensor S includes a plant factory ID, a plant factory floor ID, a cultivation bed ID, a cultivation bed shelf ID, and spatial information in which the location of the sensor S in the shelf of the cultivation bed has been represented by means of 3D spatial coordinates. Moreover, a hydroponic device 10 configured to supply nutrients and water required for the growth of plants 12, ports 11 configured such that the plants 12 can be cultivated therein, and light sources 13 configured to promote photosynthesis may be provided in the cultivation bed.

FIG. 8 is a diagram illustrating the detailed configuration of a sensor registration management unit according to an embodiment of the present invention.

Referring to FIG. 8, the registration management unit 110 according to this embodiment of the present invention sensor may include a sensor registration message transmission unit 111, a sensor registration request message reception unit 112, and a sensor registration unit 113.

The sensor registration message transmission unit 111 transfers a registration command message of at least one sensor S from the middleware 10 of the sensor network. In this case, the sensor registration message transmission unit 111 transfers the registration command message to at least one sensor S through the gateway 200 and the interface 300.

The sensor registration request message reception unit 112 receives a registration request message for the sensor registration command message from at least one sensor S. In this case, the sensor registration request message reception unit 112 receives the registration request message through the gateway 20.

The sensor registration unit 115 registers the sensor S with the sensor network.

FIG. 9 is a diagram illustrating the detailed configuration of a location registration management unit according to an embodiment of the present invention.

Referring to FIG. 9, the location registration management unit 130 according to an embodiment of the present invention may include a location registration message transmission unit 131, a location registration completion message reception unit 132, and a location storage unit 135.

The location registration message transmission unit 131 may transfer a location registration command message to at least one sensor S based on a sensor ID issued by the sensor ID issuance unit 120. In this case, location registration message transmission unit 131 transfers the location registration command message to at least one sensor S through the gateway 200 and the interface 300. The location registration command message includes a plant factory ID, a plant factory floor ID, a cultivation bed ID, a cultivation bed shelf ID, and spatial information in which the location of the sensor S in the shelf of the cultivation bed has been represented by means of 3D spatial coordinates.

The location registration completion message reception unit 132 receives a location registration completion message for the location registration command message from the at least one sensor. In this case, the location registration completion message reception unit 132 receives the registration completion message through the gateway 200.

The location storage unit 133 stores the registered information about the location of the at least one sensor S in a location information DB.

FIG. 10 is a diagram illustrating the detailed configuration of a location change management unit according to an embodiment of the present invention.

Referring to FIG. 10, the location change management unit 140 according to an embodiment of the present invention may include a location change message transmission unit 141, and a location change completion message reception unit 142.

The location change message transmission unit 141 transfers a location change command message to at least one sensor. In this case, the location change message transmission unit 141 transfers the location change command message to the sensor S through the gateway 200 and the interface 300.

The location change completion message reception unit 142 receives a location change completion message from the sensor S. In this case, the location change completion message reception unit 142 receives the location change completion message from the sensor S through the gateway 200 and the interface 300.

FIG. 11 is a diagram illustrating the detailed configuration of a location deletion management unit according to an embodiment of the present invention.

Referring to FIG. 11, the location deletion management unit 150 according to this embodiment of the present invention may include a location deletion message transmission unit 151, and a location deletion completion message reception unit 152.

The location deletion message transmission unit 151 transfers a location deletion command message to at least one sensor S. In this case, the location deletion message transmission unit 151 transfers the location deletion command message to the sensor S through the gateway 200 and the interface 300.

The location deletion completion message reception unit 152 receives a location deletion completion message from the sensor S. In this case, the location deletion completion message reception unit 152 receives the location deletion completion message from the sensor S through the gateway 200 and the interface 300.

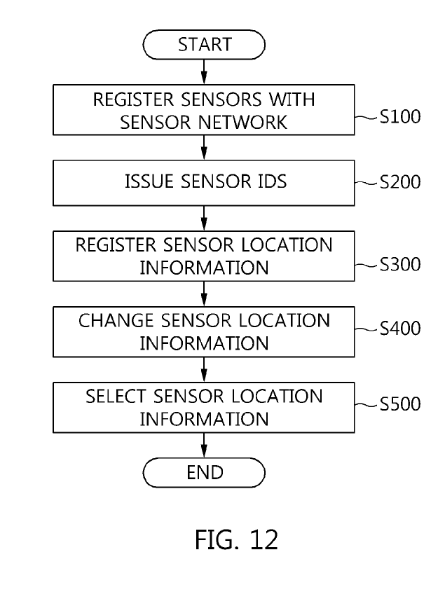

FIG. 12 is a flowchart illustrating a method of managing the locations of service equipment for a plant factory according to an embodiment of the present invention.

Referring to FIG. 12, the method of managing the locations of service equipment for a plant factory according to this embodiment of the present invention is performed using the above-described apparatus for managing the locations of service equipment for a plant factory 100. Redundant descriptions will be omitted below.

First, a registration procedure that registers a plurality of sensors with a sensor network is performed at step S 100.

Thereafter, sensor IDs are issued to the plurality of sensors registered with the sensor network, respectively, at step S200.

Thereafter, a location registration procedure that registers information about the locations of the plurality of sensors is performed based on the sensor IDs at step S300.

Thereafter, a location change procedure that changes information about the locations of the plurality of sensors is performed based on the sensor IDs at step S400.

Thereafter, a location deletion procedure that deletes information about the locations of the plurality of sensors is performed based on the sensor IDs at step S500.

Finally, the plant factory is monitored based on the information about the locations of the plurality of the sensors S that is managed through the location registration, change and location deletion procedures.

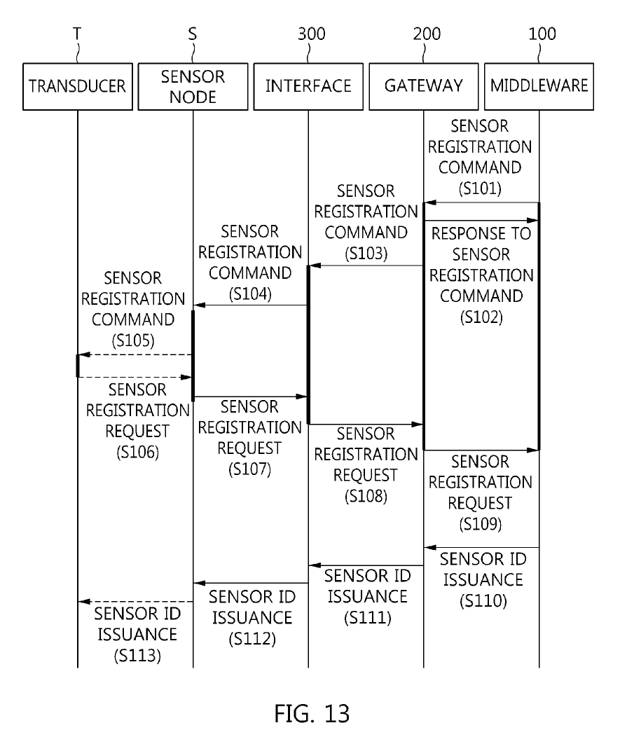

FIG. 13 is a diagram illustrating the sequence of a sensor registration procedure according to an embodiment of the present invention.

Referring to FIG. 13, in the sensor registration procedure according to this embodiment of the present invention, an administrator of the plant factory installs a plurality of sensors in the plant factory.

Thereafter, the middleware 100 transmits a registration command message for at least one sensor S to the gateway 200 at step S101. Thereafter, the gateway 200 transfers a response to the registration command message to the middleware 100 at step S 102.

Thereafter, the gateway 200 transfers the registration command message to the sensor S through the interface at steps S103 and S 104.

Thereafter, the sensor S that has received the registration command message transfers a registration request message to the interface 300 at steps S105 to S 108. In this case, if the transducer T has been integrated with the sensor S, the sensor S transfers the registration request message to the gateway 200 through the interface 300 without notification of the sensor registration command message transferred from the interface 300. Meanwhile, if the sensor S and the intelligent transducer T are separate from each other, the transducer T notifies the sensor S of the registration request message, and the registration request message is transferred to the gateway 200 through the interface 300 in the same way as described above. In this case, communications between the sensor S and the transducer T are indicated by dotted lines in the drawing. This indication is applied to the following drawings in the same way.

Thereafter, the gateway 200 that has received the registration request message from the interface 300 registers the sensor S with the sensor network by transferring the registration request message to the middleware 100 at step S 109.

Thereafter, the middleware 10 receives the registration request message, issues a sensor ID to the sensor S, and then transfers the sensor ID to the sensor S and the transducer T through the corresponding gateway 200 and interface 300 at steps S110 to S113.

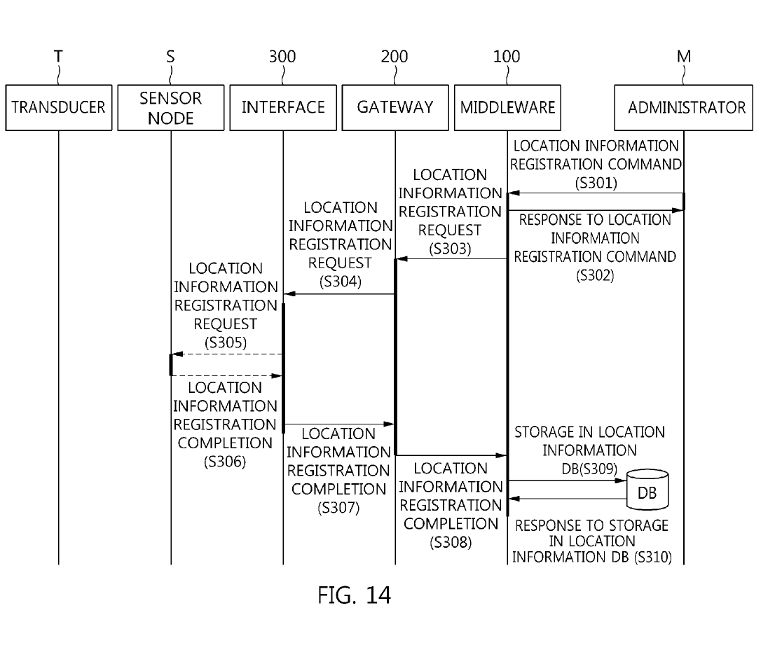

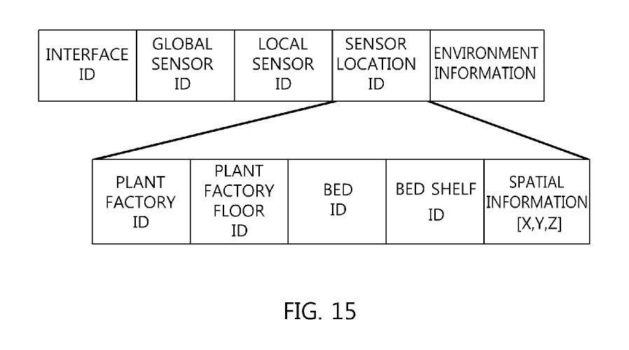

FIG. 14 is a diagram illustrating a location registration procedure according to an embodiment of the present invention, and FIG. 15 is a diagram illustrating the structure of a location registration completion message according to an embodiment of the present invention.

Referring to FIG. 14, in the location registration procedure according to this embodiment of the present invention, an administrator M of the plant factory becomes aware of a sensor ID after having performed the sensor registration procedure as described above. Accordingly, the administrator M of the plant factory manually inputs information about the location of the sensor S having the unique sensor ID using a smart device. That is, the administrator M of the plant factory instructs the middleware 100 to register information about the location of the sensor S using the smart device.

Thereafter, the middleware 200 transfers a location registration command message for at least one sensor S to the gateway 200 based on the sensor ID at step S301.

Thereafter, the gateway 300 transfers a response to the location registration command message to the middleware 200 at step S302.

Thereafter, the gateway 200 transfers the location registration command message to the interface 300 and the interface 300 transfers the location registration command message to the sensor S at steps S303 to S305.

Thereafter, the sensor S receives the location registration command message, registers the location registration command message by storing it in storage, and then transfers a location registration completion message to the gateway 20 through the interface 300 at steps S306 to S307. In this case, the structure of the location registration command message transferred from the sensor S to the interface 300 is illustrated in FIG. 15. The location registration command message transferred from the sensor S includes an interface ID, a global sensor ID, a local sensor ID issued by the middleware 100, a sensor location ID input by the administrator M of the plant factory, and environment information. In this case, the global sensor ID includes information about the port count of a sensor node and the IP address of the gateway 200, and the sensor S location ID includes a plant factory ID, a plant factory floor ID, a cultivation bed ID, a cultivation bed shelf ID, and spatial information in which the location of the sensor S in the shelf of the cultivation bed has been represented by means of 3D spatial coordinates, that is, sensor location information.

Thereafter, the gateway 20 that has received the location registration completion message through the interface 300 transfers the location registration completion message to the middleware 100 at step S308.

Thereafter, the middleware 100 that has received the location registration completion message through the interface 300 and the gateway 200 determines that the sensor S has completed location registration, and then stores the information about the location of the sensor S in a location information DB. In this case, the location information DB may make a response regarding the completion of storage after having store the information about the location of the sensor S at steps S309 and S310.

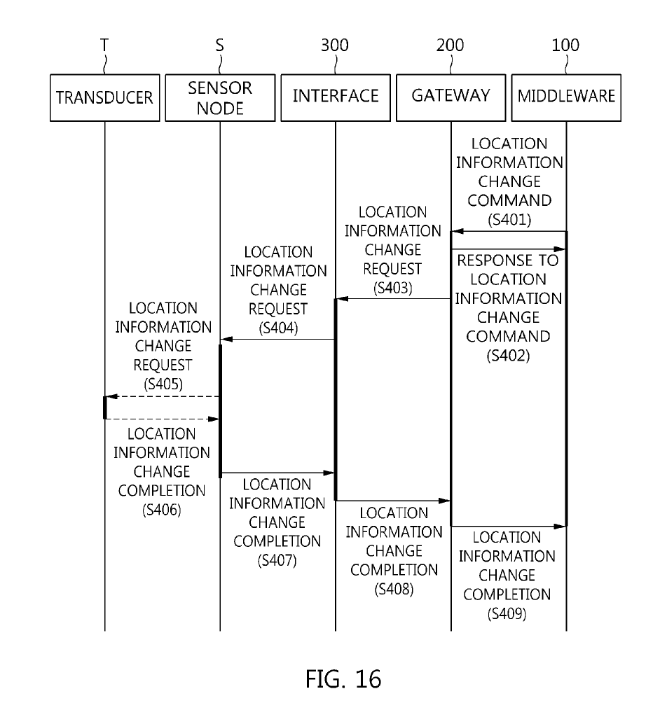

FIG. 16 is a diagram illustrating a location change procedure according to an embodiment of the present invention.

Referring to FIG. 16, the location change procedure according to this embodiment of the present invention is performed when an administrator of the plant factory changes stored information about the location of at least one sensor S. In the location change procedure according to this embodiment of the present invention, the administrator of the plant factory instructs the middleware 100 to change the information about the location of the sensor S. In this case, the administrator of the plant factory may issue not only an instruction to change the information about the location of the sensor S but also an instruction to change other sensor information.

Thereafter, the middleware 100 transfers a location change command message to the gateway 200 based on the changed information about the location of the sensor S at step S401. Thereafter, the gateway 200 makes a response to the corresponding command at step S402.

Thereafter, the gateway 200 transfers the location change command message transferred by the middleware 100 to the interface 300, and the interface 300 transfers the location change command message to the sensor S at steps S403 to S405. In this case, if the sensor S is provided with an intelligent transducer T that is not separate, the location change command message is transferred to the transducer T.

Thereafter, the sensor S transfers a location change completion message to the interface 300 after having changed the location at step S406, and the interface 30 transfers the location change completion message to the gateway 200 at steps S407 and S408.

Thereafter, the gateway 20 transfers the location change completion message to the middleware 10 at step S409.

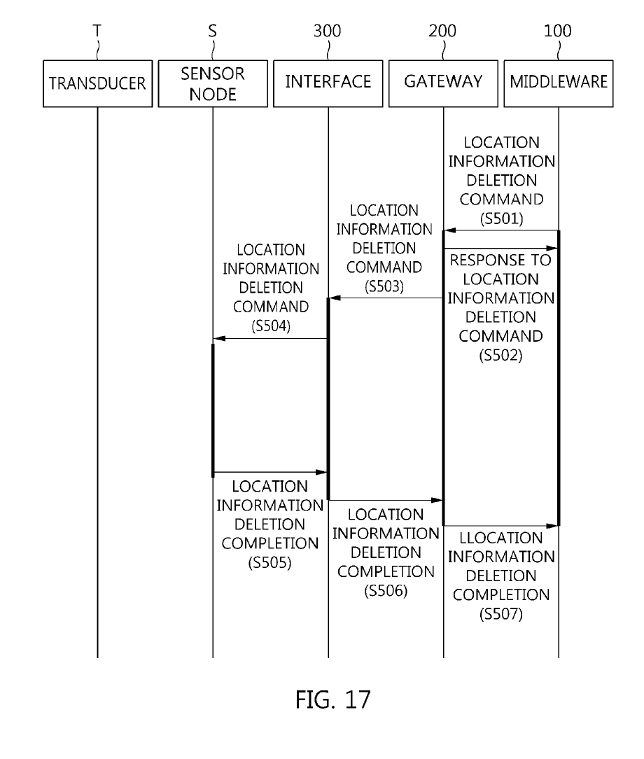

FIG. 17 is a diagram illustrating a location deletion procedure according to an embodiment of the present invention.

Referring to FIG. 17, in the location deletion procedure according to this embodiment of the present invention, when an administrator of the plant factory desires to replace at least one sensor S with a new sensor because of the deterioration of the sensor S, the administrator instructs the middleware 100 to delete information about the location of the sensor S in order to delete the sensor S.

Thereafter, the middleware 100 transfers a location deletion command message to the gateway 200 at step S501. Thereafter, the gateway 200 makes a response to the corresponding command and transfers the response to the corresponding sensor S through the interface 300 at step S502.

Thereafter, the gateway 200 transfers the location deletion command message to the sensor S through the interface 300 at steps S503 and S504.

Thereafter, the sensor S deletes the location information and then transfers a location deletion completion message to the gateway 200 through the interface 300 at steps S505 and S506.

Thereafter, the gateway 200 transfers the location deletion completion message to the middleware 100 at step S507.

The apparatus and method for managing the locations of service equipment for a plant factory according to the present invention can register, delete and change the locations of a plurality of service devices and sensors when the service devices and the sensors are installed or moved in a plant factory, thereby achieving the advantage of collecting information about the accurate locations of the service devices and the sensors.

Furthermore, the apparatus and method for managing the locations of service equipment for a plant factory according to the present invention has the advantage of collecting information about the locations of a plurality of service devices and sensors installed in a plant factor via a sensor network, easily determining the locations of the service devices and the sensors based on the information about the service devices and the sensors, and then precisely controlling an environment inside the plant factory based on the information about the service devices and the sensors.

Moreover, the apparatus and method for managing the locations of service equipment for a plant factory according to the present invention has the advantage of solving problems occurring inside the plant factory based on information about the accurate locations of a plurality of service devices and the sensors.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of managing locations of service equipment for a plant factory, comprising:
performing a registration procedure that registers with a sensor network a plurality of service devices and sensors that are installed in the plant factory;
issuing sensor identifications to the plurality of service devices and sensors registered with the sensor network, respectively; and
performing a location registration procedure that registers information about locations of the plurality of service devices and sensors based on the issued sensor identifications.

2. The method of claim 1, wherein performing the registration procedure comprises:
transferring a sensor registration command message to the at least one of the plurality of service devices and sensors through a gateway and an interface;
receiving a registration request message for the sensor registration command message from the at least one of the plurality of service devices and sensors through the gateway and the interface; and
registering the at least one of the plurality of service devices and sensors with the sensor network.

3. The method of claim 1, wherein performing the location registration procedure comprises:
transferring a location registration command message to at least one of the plurality of service devices and sensors through a gateway and an interface based on the sensor IDs;
receiving a location registration completion message for the location registration command message from the at least one of the plurality of service devices and sensors through the gateway and the interface; and
storing the information about the final location of the at least one of the plurality of service devices and sensors in a location information database.

4. The method of claim 3, wherein the location registration command message comprises at least one of a plant factory identification, a plant factory floor identification, a cultivation bed identification, a cultivation bed shelf identification, and spatial information in which the location of the sensor in a shelf of a corresponding cultivation bed has been represented by means of 3D spatial coordinates.

5. The method of claim 4, wherein the 3D spatial coordinates are set in such a way that X, Y, and Z axes are set across a 3D space of the shelf of the cultivation bed so that they are orthogonal to each other, the X axis is uniformly divided into X_left, X_center and X_right along an outward direction from an origin, the Y axis is uniformly divided into Y_right, Y_center and Y_left along the outward direction from the origin, and the Z axis is uniformly divided into Z_low, Z_medium and Z_high along the outward direction from the origin.

6. The method of claim 1, further comprising, after performing the location registration procedure, performing a location change procedure that changes the information about the location of at least one of the plurality of service devices and sensors based on the sensor identifications.

7. The method of claim 6, wherein performing the location change procedure comprises:
transferring a location change command message to the at least one of the plurality of service devices and sensors through a gateway and an interface based on the sensor identifications; and
receiving a location change completion message for the location change command message from the at least one of the plurality of service devices and sensors through the gateway and the interface.

8. The method of claim 1, further comprising, after performing the location registration procedure, performing a location deletion procedure that deletes the information about the location of at least one of the plurality of service devices and sensors based on the sensor identifications.

9. The method of claim 8, wherein performing the location deletion procedure comprises:
transferring a location deletion command message to the at least one of the plurality of service devices and sensors through a gateway and an interface based on the sensor identifications; and
receiving a location deletion completion message for the location deletion command message from the at least one of the plurality of service devices and sensors through the gateway and the interface.

10. An apparatus for managing locations of service equipment for a plant factory, comprising:
a sensor registration management unit configured to perform a registration procedure that registers with a sensor network a plurality of service devices and sensors that are installed in the plant factory;
a sensor identifications issuance unit configured to issue sensor identifications to the plurality of service devices and sensors registered with the sensor network, respectively; and
a location registration management unit configured to perform a location registration procedure that registers information about locations of the plurality of service devices and sensors based on the issued sensor identifications.

11. The apparatus of claim 10, wherein the sensor registration management unit comprises:
a registration command message transmission unit configured to transfer a sensor registration command message transferred by an administrator to at least one of the plurality of service devices and sensors through a gateway and an interface;
a registration request message reception unit configured to receive a registration request message for the sensor registration command message from the at least one of the plurality of service devices and sensors through the gateway and the interface; and
a sensor registration unit configured to register the at least one of the plurality of service devices and sensors with the sensor network.

12. The apparatus of claim 10, wherein the location registration management unit comprises:
a location registration message transmission unit configured to transfer a location registration command message to at least one of the plurality of service devices and sensors through a gateway and an interface based on the sensor identifications;
a location registration message reception unit configured to receive a location registration completion message for the location registration command message from the at least one of the plurality of service devices and sensors through the gateway and the interface; and
a location storage unit configured to store the information about the final location of the at least one of the plurality of service devices and sensors in a database.

13. The apparatus of claim 12, wherein the location registration command message comprises at least one of a plant factory identification, a plant factory floor identification, a cultivation bed identification, a cultivation bed shelf identification, and spatial information in which the location of the sensor in a shelf of a corresponding cultivation bed has been represented by means of 3D spatial coordinates.

14. The apparatus of claim 13, wherein the 3D spatial coordinates are set in such a way that X, Y, and Z axes are set across a 3D space of the shelf of the cultivation bed so that they are orthogonal to each other, the X axis is uniformly divided into X_left, X_center and X_right along an outward direction from an origin, the Y axis is uniformly divided into Y_right, Y_center and Y_left along the outward direction from the origin, and the Z axis is uniformly divided into Z_low, Z_medium and Z_high along the outward direction from the origin.

15. The apparatus of claim 10, further comprising a location change management unit configured to perform a location change procedure that changes the information about the location of at least one of the plurality of service devices and sensors based on the sensor identifications.

16. The apparatus of claim 15, wherein the location change management unit comprises:
a location change message transmission unit configured to transfer a location change command message to the at least one of the plurality of service devices and sensors through a gateway and an interface based on the sensor identifications; and
a location change message reception unit configured to receive a location change completion message for the location change command message from the at least one of the plurality of service devices and sensors through the gateway and the interface.

17. The apparatus of claim 10, further comprising a location deletion management unit configured to perform a location deletion procedure that deletes the information about the location of at least one of the plurality of service devices and sensors based on the sensor identifications.

18. The apparatus of claim 17, wherein the location deletion management unit comprises:
a location deletion message transmission unit configured to transfer a location deletion command message to the at least one of the plurality of service devices and sensors through a gateway and an interface based on the sensor identifications; and
a location deletion message reception unit configured to receive a location deletion completion message for the location deletion command message from the at least one of the plurality of service devices and sensors through the gateway and the interface.
